(19) United States
(12) Patent Application Publication
(10) Pub. No.: US 2014/0196564 A1
(43) Pub. Date: Jul. 17, 2014

(54) STEERING COLUMN OF VEHICLE

(71) Applicant: MANDO CORPORATION, Pyeongtaek-si (KR)

(72) Inventors: Gwi Sik BANG, Seongnam-si (KR); Sang CHUL Ku, Seoul (KR)

(73) Assignee: MANDO CORPORATION, Pyeongtaek-si (KR)

(21) Appl. No.: 14/154,471

(22) Filed: Jan. 14, 2014

(30) Foreign Application Priority Data
Jan. 15, 2013 (KR) 10-2013-0004356
Jan. 22, 2013 (KR) 10-2013-0006866

(51) Int. Cl. B62D 1/187

(52) U.S. Cl. CPC B62D 1/187
USPC 74/493

(57) ABSTRACT

The present invention relates to a steering column of a vehicle. In the steering column, inclined telescopic long holes are formed in the telescopic guide portions, thereby solving the problem of uneven diffusion of a lever force. Further, locking operations after tilt and telescopic operations can be achieved only with tilt locking gears. Therefore, the number of required elements can be reduced, material costs can be reduced and the column can be configured in a compact size.

### CROSS-REFERENCE TO RELATED APPLICATION

This application claims priority from and the benefit under 35 §119(a) of Korean Patent Application Nos. 10-2013-0004356 & 10-2013-0006866, filed on Jan. 15, 2013 & Jan. 22, 2013, which are hereby incorporated by reference for all purposes as if fully set forth herein.

### BACKGROUND OF THE INVENTION

1. Field of the Invention

The present invention relates to a steering column of a vehicle, and more particularly to a steering column of a vehicle in which an inclined telescopic long hole is formed in a telescopic guide portion so that a problem of uneven distribution of lever force can be solved, and both locking after a tilt operation and locking after a telescopic operation can be achieved only with tilt locking gears so that the number of required elements can be reduced, material costs can be reduced and the steering column can be configured in a compact size.

2. Description of the Prior Art

FIG. 1 is a perspective view illustrating a part of a conventional steering column of a vehicle. FIG. 2 is a bottom view illustrating a part of the steering column of FIG. 1.

As illustrated in the drawings, a conventional steering column 100 of a vehicle includes: an upper tube 120 that accommodates a steering shaft 175 connected to a steering wheel (not illustrated) and includes telescopic guide portions 153 at both sides of the bottom part thereof in a direction parallel to the steering shaft, the telescopic guide portions 153 being formed with telescopic guide holes 155; a lower tube 110 inserted into the upper tube 120; a mounting bracket 135 installed at a top side of the upper tube 120 and fixed to a vehicle body; tilt brackets 130 and 131 coupled to the mounting bracket 135 and formed with tilt long holes 137a and 137b; an adjustable bolt 160 coupled through the tilt long holes 137a and 137b and the telescopic guide holes 155, one end of the adjustable bolt 160 being formed with a head portion 183 and the other end being engaged with a bearing 117 and a locking nut 119; and a cam assembly 115 including a operation cam formed on a lever 140 and a fixed cam coupled to the tilt bracket 130.

The telescopic operation is completed by releasing the lever 140, then changing the position of the adjustable bolt 160 along the telescopic guide holes 155 formed in the telescopic guide portions 153, and then tightening the lever 140.

The tilt operation is completed by releasing the lever 140, then changing the position of the adjustable bolt 160 along the tilt long holes 137a and 137b, and then tightening the lever 140.

Meanwhile, the position of the upper tube 120 is changed depending on the tilt or telescopic operation, thereby changing the relative position of the telescopic guide portions 153 in relation to the tilt brackets 130 and 131. As a result, when separately considering central positions where tightening forces are applied to telescopic guide portions 153 when tightening the lever 140 as P1 and P2 in FIG. 2, the lever force at P1 is larger than the lever force at P2.

That is, a slot 210 formed on the outer circumferential surface of the upper tube 120 between the telescopic guide portions 153 so as to allow the distance between the telescopic guide portions 153 to be narrowed when a driver tightens the lever 140. One end (steering wheel side end) of the slot 210 is closed and the other end is opened.

Accordingly, the lever force applied by the driver so as to tighten the lever 140 is reduced toward the opened end of the slot 210. Consequently, the distribution of the lever force becomes uneven depending on the change of position of the upper tube 120, thereby deteriorating the lever operating feeling of the driver.

### SUMMARY OF THE INVENTION

Accordingly, the present invention has been made to solve the above-mentioned problems occurring in the prior art, and an object of the present invention is to provide a steering column of a vehicle in which an inclined telescopic long hole is formed in a telescopic guide portion, thereby solving a problem of uneven distribution of a lever force.

Another object of the present invention is to provide a steering column of a vehicle in which both locking after a tilt operation and locking after a telescopic operation can be performed only by tilt locking gears so that the number of required elements can be reduced, material costs can be reduced and the column can be configured in a compact size.

The present invention is not limited to the foregoing and other objects of the present invention can be apparently understood by a person ordinarily skilled in the art from the descriptions set forth below.

According to an exemplary embodiment of the present invention, there is provided a steering column of a vehicle, including: a hollow lower tube that encloses a steering shaft connected to a steering wheel; and an upper tube formed in a hollow shape such that the lower tube is inserted into and coupled to the upper tube. The upper tube includes telescopic guide portions that protrude from an outer circumferential surface of the upper tube to face each other and are formed with telescopic long holes through which an adjustable bolt is coupled. The telescopic long holes are formed to be inclined by a predetermined angle in relation to a direction parallel to a direction of a central axis of the steering shaft, and a slot cut in the direction of the central axis of the steering shaft is formed on the outer circumferential surface between the telescopic guide portions.

According to another exemplary embodiment of the present invention, there is provided a steering column of a vehicle, including: an upper tube, into which a hollow lower tube enclosing a steering shaft is inserted to be coupled, the upper tube including telescopic guide portions that protrude from an outer circumferential surface of the upper tube to face each other and are formed with telescopic long holes through which an adjustable bolt are coupled, the telescopic long holes being formed to be inclined by a predetermined angle in relation to a direction parallel to the direction of a central axis of the steering shaft; a tilt locking gear assembly including a first tilt locking gear coupled to one side of plate brackets provided at both sides of the telescopic guide portions, a second tilt locking gear engaged with the first tilt locking gear, and an elastic support interposed between the first tilt locking gear and the second tilt locking gear to provide an elastic supporting force to the second tilt locking gear; and a cam assembly including a fixed cam that is coupled to the other side of the plate brackets and formed with a first cam protrusion, and an operation cam that is formed with a second cam protrusion, which abuts against the first cam protrusion, an adjustment lever being coupled with the operation cam.

According to the exemplary embodiments of the present invention, because the telescopic long holes formed in the telescopic guide portions are formed to be inclined, the problem of uneven diffusion of a lever force can be solved.

In addition, because both locking after the tilt operation and locking after the telescopic operation can be achieved only with the tilt locking gears, the number of required elements can be reduced, material costs can be reduced, and the steering column can be configured in a compact size.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating a part of a conventional steering column of a vehicle;

FIG. 2 is a bottom view illustrating a part of the steering column of FIG. 1;

FIG. 3 is a perspective view illustrating a part of a steering column of a vehicle according to a first exemplary embodiment of the present invention;

FIG. 4 is a view illustrating a telescopic long hole of FIG. 3;

FIG. 5 is a view that compares the conventional steering column and the steering column of FIG. 3;

FIG. 6 is a perspective view illustrating a steering column of a vehicle according to a second exemplary embodiment of the present invention;

FIG. 7 is a perspective view illustrating the steering column of FIG. 6 in a partially disassembled state;

FIG. 8 is an exploded perspective view of a tilt locking gear assembly of FIG. 7; and

FIG. 9 is a side view illustrating a structure of a telescopic guide portion of FIG. 7.

### DETAILED DESCRIPTION OF THE PREFERRED EMBODIMENTS

Hereinafter, exemplary embodiments of the present invention will be described with reference to the accompanying drawings. It should be noted that if it is described in the specification that one component is “connected,” “coupled” or “joined” to another component, a third component may be “connected,” “coupled,” and “joined” between the first and second components, although the first component may be directly connected, coupled or joined to the second component.

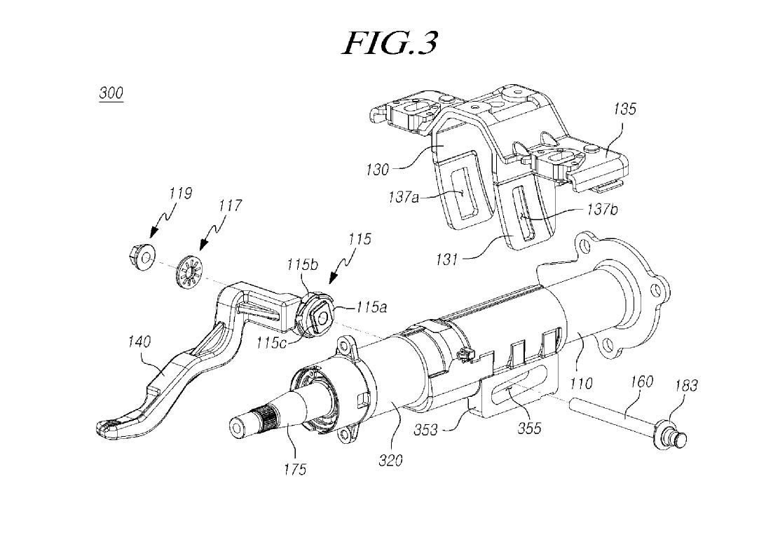

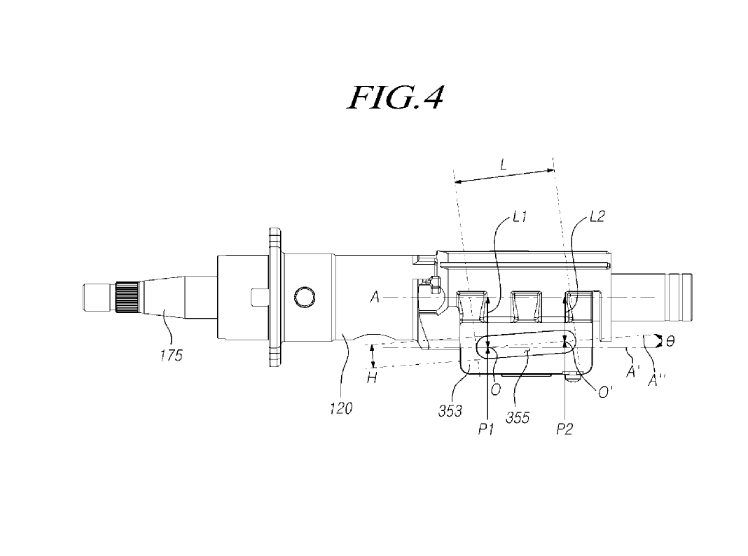

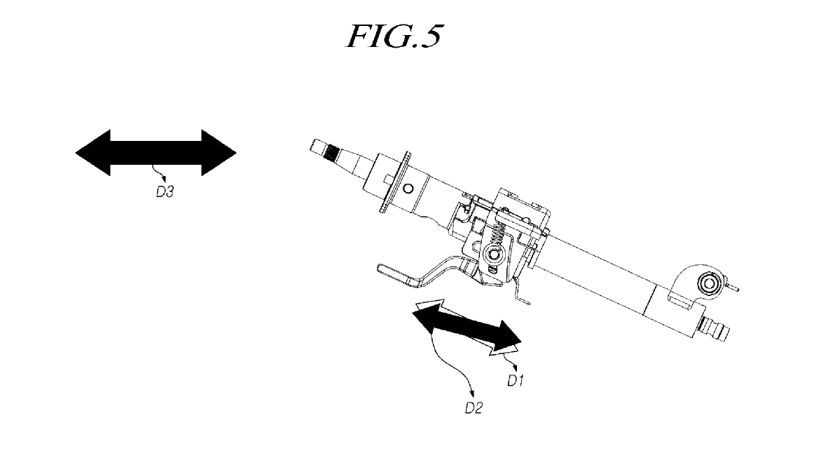

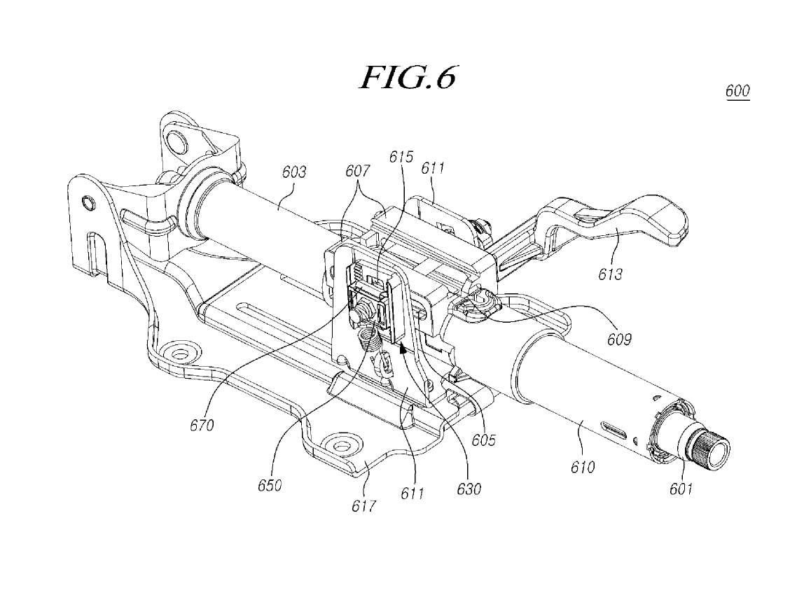

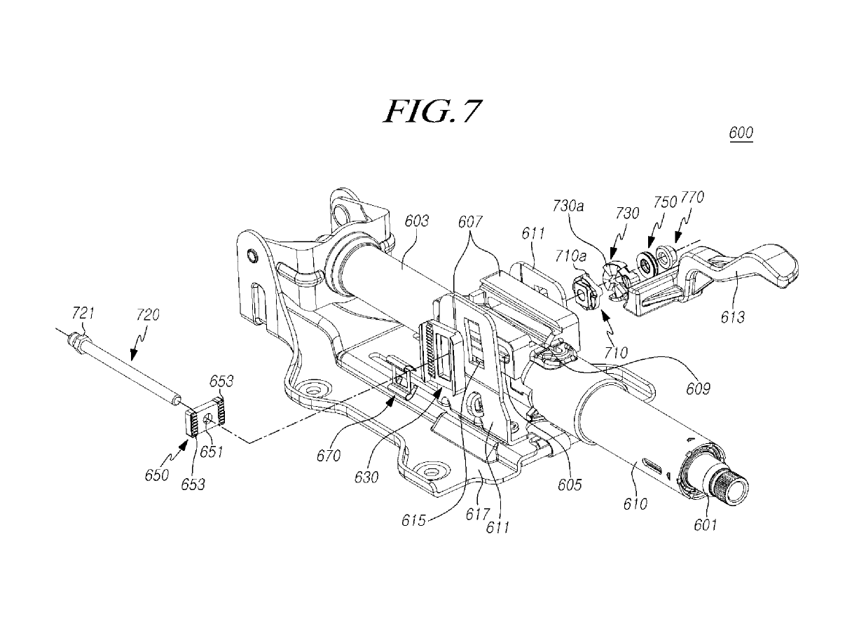

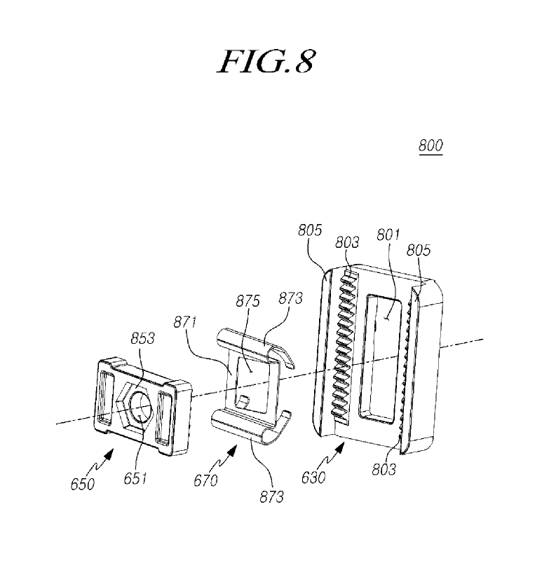

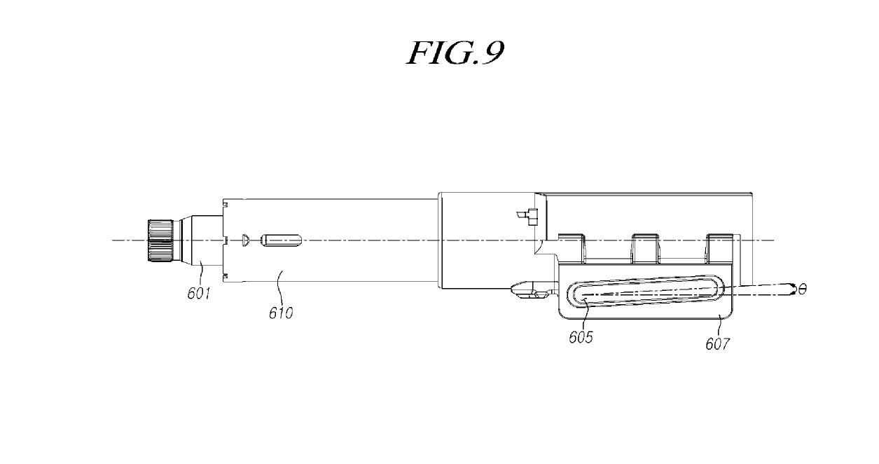

FIG. 3 is a perspective view illustrating a part of a steering column of a vehicle according to a first exemplary embodiment of the present invention. FIG. 4 is a view illustrating a telescopic long hole of FIG. 3. FIG. 5 is a view that compares the conventional steering column and the steering column of FIG. 3. FIG. 6 is a perspective view illustrating a steering column of a vehicle according to a second exemplary embodiment of the present invention. FIG. 7 is a perspective view illustrating the steering column of FIG. 6 in a partially disassembled state. FIG. 8 is an exploded perspective view of a tilt locking gear assembly of FIG. 7. FIG. 9 is a side view illustrating a structure of a telescopic guide portion of FIG. 7.

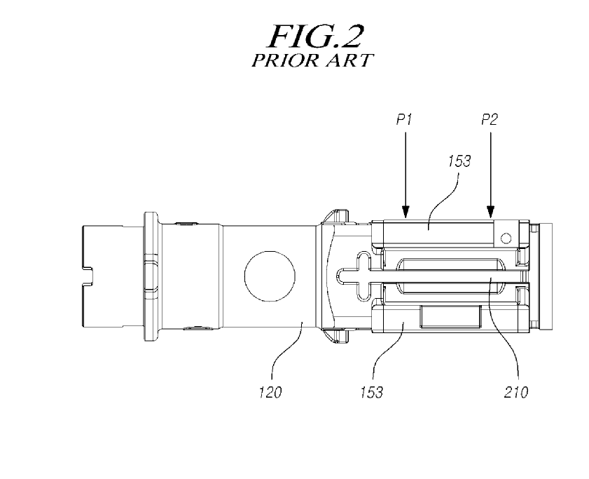

Referring to these drawings together with FIG. 2, a steering column 300 of a vehicle includes: a hollow lower tube 110 that encloses a steering shaft 175 connected to a steering wheel (not illustrated); and an upper tube 320 formed in a hollow shape such that the lower tube 110 is inserted into and coupled to the upper tube 320. The upper tube 320 is provided with telescopic guide portions 353 that protrude from an outer circumferential surface of the upper tube 320 to face each other and are formed with telescopic long holes 355, through which an adjustable bolt 160 is inserted to be coupled. The telescoping long holes 355 are formed to be inclined by a predetermined angle θ in relation to a direction A′ parallel to an direction of a central axis A of the steering shaft 175, and a slot 210 cut in the direction of the central axis A of the steering shaft is formed on the outer circumferential surface between the telescopic guide portions 353.

The mounting bracket 135 is coupled to a vehicle body at the top side of the upper tube 320 and tilt brackets 130 and 131 are coupled to the mounting bracket 135.

The tilt brackets 130 and 131 are provided to enclose the both sides of the upper tube 320 in which the top sides of the tilt bracket 130 and 131 are connected with each other and the tilt brackets 130 and 131 are formed with tilt long holes 137a and 137b, respectively.

The adjustable bolt 160 is coupled by being inserted through the tilt long holes 137a and 137b and the telescopic long holes 355. One end of the adjustable bolt 160 is formed with a head portion 183 and the other end is coupled with a bearing 117 and a locking nut 119.

The lever 140 is formed with an operation cam 115b which is configured to be relatively rotated in relation to a fixed cam 115a coupled to the tilt bracket 130.

That is, when a driver rotates the lever 140 in one direction to be locked, the operation cam 115b is relatively rotated in relation to the fixed cam 115a and spaced apart from the fixed cam 115a by a level difference in the cam, thereby tightening the tilt brackets 130 and 131.

Meanwhile, since the fixed cam 115a is formed with a protrusion 115c which is inserted into the tilt long hole 137a of the tilt bracket 130, the fixed cam 115a is not rotated even if the operation cam 115b is rotated when the driver rotates the lever 140.

The lower tube 110 is provided in a hollow shape to enclose the steering shaft 175 connected with the steering wheel (not illustrated). The lower tube 110 is inserted into the upper tube 320.

The upper tube 320 is provided in a hollow shape to have a structure where the lower tube 110 is inserted and coupled as described above.

In addition, the upper tube 320 is formed with the telescopic guide portions 353, and a slot 210 (see FIG. 2) cut in the direction of the central axis A of the steering shaft 175 is formed on the outer circumferential surface between the telescopic guide portions 353 of the upper tube 320. As described above, the slot 210 is formed on the outer circumferential surface of the upper tube 120 between the telescopic guide portions 153 so that the distance between telescopic guide portions 353 can be narrowed when the driver tightens the lever 140. The slot 210 is closed at one end (the steering wheel side end) and opened at the other end.

Meanwhile, the telescopic guide portions 353 protrude from the outer circumferential surface upper tube 320 to face each other and are formed with the telescopic long holes 355 through which the adjust bolt 150 is coupled. The opposite ends of the telescopic long holes 355 may be rounded with a radius corresponding to the radius of the adjustable bolt 160.

Here, the telescopic long holes 355 are formed to be inclined by a predetermined angle θ in relation to a direction A′ parallel to the central axis A of the steering shaft 175. For example, the telescopic long holes 355 may be inclined such that a distance L1 between the steering wheel (not illustrated) side ends of the telescopic long holes 355 and the central axis A of the steering shaft 175 is longer than a distance L2 between the other side ends of the telescopic long holes 355 and the central axis A of the steering shaft 175.

In order to describe the structure of the telescopic long hole 355 according to the first exemplary embodiment of the present invention, in FIG. 4, the center of the round portion at the steering wheel (not illustrated) side ends of the telescopic long holes 355 is indicated by O, the center of the round portion? at the other side ends is indicated O′, the entire length of the telescopic long holes 355 (for example, 48 mm to 49 mm) is indicated by L, and the width of the telescopic long holes 355 (for example, 8 mm to 9 mm) is indicated by H. In addition, the axis passing the centers O and O′ is indicated by A″, the axis passing the center O in parallel to the central axis A of the steering shaft 175 is indicated by A′, the distance from the central axis A of the steering shaft 175 to the center O (for example, 27 mm 28 mm) is indicated by L1, the distance from the central axis A of the steering shaft 175 and the center O′ (for example, 24 mm to 25 mm) is indicated by L2, and the angle formed between the central axes A′ and A″ with reference to the center O (for example, 10° to 15°) is indicated by θ.

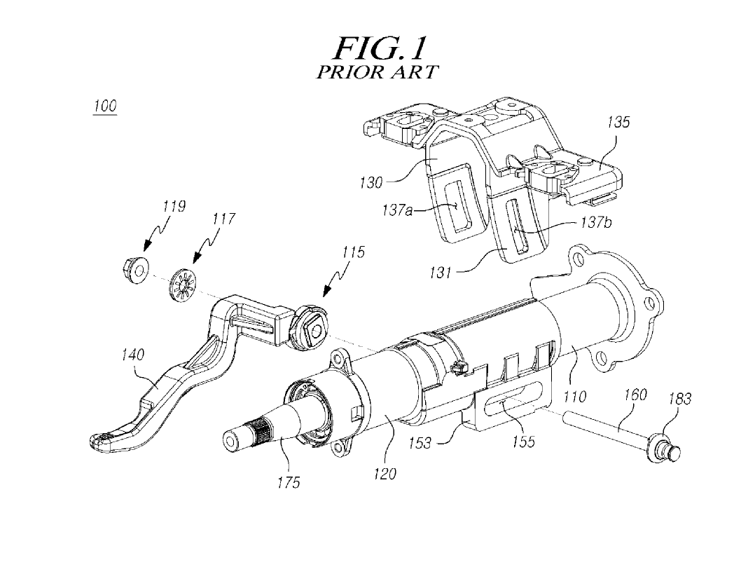

Referring to FIG. 4, in the conventional steering column of a vehicle, the telescopic guide holes 155 formed in the telescopic guide portions 153 are formed in parallel to the axis A′ (see FIG. 1) but in the steering column in the first exemplary embodiment of the present invention, the telescopic long holes 355 formed in the telescopic guide portions 353 are formed in parallel to the axis A″.

Accordingly, as compared with the conventional telescopic guide holes 155, the telescopic long holes 355 are formed to be inclined by the angle θ, and thus, the distance L2 from the axis A to the center O′ is shorter than the distance L1 from the axis A to the center O. Due to this, according to the first exemplary embodiment, the problem of uneven distribution of lever force in the prior art can be solved.

That is, as described above, in the prior art, there was uneven distribution in lever force because the lever force at P1 is larger than the lever force at P2. However, when the telescopic long holes 355 are formed to be inclined according to the exemplary embodiment of the present invention, because L2 is shorter than L1, the lever force applied to P2 is increased and thus, the lever forces at P1 and P2 may become even.

Meanwhile, when the telescopic long holes 355 are formed to be inclined, as illustrated in FIG. 5, the direction D2 of the telescopic long holes 355 are more coincident with the direction D3 of the force applied by the driver for the telescopic operation, as compared to the direction of the conventional guide holes 155. Thus, the tilt operation can be additionally performed even if the driver only performs the telescopic operation.

That is, when the driver pushes the steering wheel so that the upper tube 120 is moved diagonally downward, a tilt-up effect may occur as compared to the prior art, and on the contrary, when the drier pulls the steering wheel so that the upper tube 120 is moved diagonally upward, a tilt-down effect may occur.

As described above, according to the first exemplary embodiment of the present invention, the problem of uneven distribution of lever force can be solved by forming the telescopic long holes in the telescopic guide portions to be inclined.

Meanwhile, a steering column 600 of a vehicle according to a second exemplary embodiment of the present invention includes: an upper tube 610 formed in a hollow shape into which a hollow lower tube 603, which encloses a steering shaft 601, is inserted to be coupled, the upper tube being provided with telescopic guide portions 607 which protrude from an outer circumferential surface of the upper tube 610 to face each other and are formed with telescopic long holes 605 through which an adjustable bolt 720 are inserted to be coupled, the telescopic long holes 605 being formed to be inclined by a predetermined angle in relation to a direction parallel to the direction of a central axis of the steering shaft 601, and a slot 609 cut in the direction of the central axis of the steering shaft 601 being formed on the outer circumferential surface of the upper tube 610 between the telescopic guide portions 607; a tilt locking gear assembly 800 including a first tilt locking gear 630 coupled to one side of plate brackets 611 provided at both sides of the telescopic guide portions 607, a second tilt locking gear 650 engaged with the first tilt locking gear 630, and an elastic support 670 interposed between the first tilt locking gear 630 and the second tilt locking gear 650 to provide an elastic supporting force to the second tilt locking gear 650; and a cam assembly including a fixed cam 710 which is coupled to the other side of the plate brackets 611 and formed with a first cam protrusion 710a, and an operation cam 730 which is formed with a second cam protrusion 730a, which abuts against the first cam protrusion 710a, an adjustment lever 613 being coupled with the operation cam 730.

The lower tube 603 is formed in a hollow tube shape and the steering shaft 601 is inserted into the inside of the lower tube 603.

The upper tube 610 is formed in a hollow tube shape and the lower tube 603 is inserted into the inside of the upper tube 610. On the outer circumferential surface of the upper tube 610, the telescopic guide portions 607 are formed to face with each other. The telescopic guide portions 607 are formed with the telescopic long holes 605 in which the telescopic long holes 605 are formed to be inclined by a predetermined angle θ (see FIG. 9) in relation to the axial direction of the steering shaft 601 and the adjustable bolt 720 is inserted through the telescopic long holes 605. The effects obtained by forming the telescopic long holes 605, which are formed in the telescopic guide portions 607, to be inclined by a predetermined angle θ in relation to the axial direction of the steering shaft 601 are the same as those described above.

The telescopic guide portions 607 are formed to protrude outwardly from the outer circumferential surface of the upper tube 610 and the slot 609 cut in the axial direction is formed on the outer circumferential surface between the telescopic guide portions 607 of the upper tube 610 in the same shape as the above-mentioned slot 210 to perform the same function as the slot 210. The plate brackets 611 are provided at the outer opposite sides of the telescopic guide portions 607.

The plate brackets 611 are formed substantially in a “U” shape and provided at the opposite sides of the telescopic guide portion 607 to enclose the outer circumferential surface of the upper tube 610. The plate brackets 611 are formed with tilt long holes 615 so that the adjustable bolt 720 is coupled through the tilt long holes 615 as well as the telescopic long holes 605.

The plate brackets 611 are coupled to a mounting bracket 617 to be fixed to a vehicle body.

The tilt locking gear assembly 800 includes the first tilt locking gear 630 coupled to the one side of the plate bracket 611, the second tilt locking gear 650 engaged with the first tilt locking gear 630, and the elastic support 670 interposed between the first tilt locking gear 630 and the second tilt locking gear 650 to provide an elastic supporting force to the second tilt locking gear 650.

The structures of the first tilt locking gear 630, the second tilt locking gear 650, and the elastic support 670 will be discussed in more detail with reference to FIGS. 7 and 8.

The first tilt locking gear 630 is formed with a first hole 801 at the center thereof, through which the adjustable bolt 720 is inserted, and first gear teeth 803 are formed at both sides of the first hole 801 to be parallel to each other.

In addition, the first tilt locking gear 630 may be formed with guide bars 805 protruding toward the second tilt locking gear 650 at the both sides of the first gear teeth 803, respectively. The guide bars 805 serve to guide the moving direction of the second tilt locking gear 650.

The second tilt locking gear 650 is formed with a second hole 651 at the center thereof, though which the adjustable bolt 720 is inserted, and second gear teeth 653 are formed at the both sides of the second hole 651 to be parallel to each other. The second gear teeth 353 are engaged with the first gear teeth 803.

Meanwhile, the second tilt locking gear 650 may be formed in a rectangular shape as illustrated and a stepped groove 853 sunk in a polygonal shape is formed around the second hole 651 on the surface opposite to the surface formed with the second gear teeth 653.

In addition, a head portion 721 formed in a polygonal shape at an end of the adjustable bolt 720 is inserted into the stepped groove 853.

When the polygonal stepped groove 853 is formed in the second tilt locking gear 650 and the head portion 721 of the adjustable bolt 720 in the polygonal shape as described above, the head portion 721 of the adjustable bolt 720 may be inserted into and firmly coupled to the stepped groove 853 of the second tilt locking gear 650.

The elastic support 670 includes a hollow body portion 871 on which the second tilt locking gear 650 abuts to be supported and elastic support legs 873 protruding toward the second tilt locking gear 650 at the both sides of the body portion 871 and then bent toward the first tilt locking gear 630 to be supported by the first tilt locking gear 630 so as to provide an elastic supporting force to the second tilt locking gear 650.

The body portion 871 is formed with a hole 875 at the center thereof, though which the adjustable bolt 720 is inserted, and the surface of the second tilt locking gear 650 between the second gear teeth 653 abuts on the body portion 871 to be stably supported.

The elastic support legs 873 are formed so as to provide the elastic supporting force to the second tilt locking gear 650. Referring to FIG. 8, the elastic support legs 873 are supported by the surface between the first hole 801 and the first gear teeth 803 in the first tilt locking gear 630.

Meanwhile, because the elastic support legs 873 are formed by protruding toward the second tilt locking gear 650 at both sides of the body portion 871 and then being bent toward the first tilt locking gear 630 again as described above, the portions of the elastic support legs 873 protruding toward the second tilt locking gear 650 may stably support the second tilt locking gear 650.

The cam assembly includes the fixed cam 710 which is coupled to the other side of the plate bracket 611 and formed with a first cam protrusion 710a, and the operation cam 730 which is formed with a second cam protrusion 730a abutting against the first cam protrusion 710a and to which the adjustment lever 613 is coupled.

Therefore, when the driver rotates the adjustment lever 613 in one direction or the other direction, the second cam protrusion 730a of the operation cam 730 is moved along the first cam protrusion 710a of the fixed cam 710 and thus, the distance between the operation cam 730 and the fixed cam 710 is changed to lock or unlock the adjustment lever 613.

Meanwhile, the adjustable bolt 720 is coupled through the second tilt locking gear 650, the elastic support 670, the first tilt locking gear 630, the plate bracket 611, the telescopic guide portions 607, the fixed cam 710, and the operation cam 730. As described above, the adjustable bolt 720 is formed with the head portion 721 at one end thereof, and the bearing 750 and the locking nut 770 are coupled to the other end of the adjustable bolt 720 in sequence.

Referring to the drawings, descriptions will be made on an operating example of the steering column of a vehicle according to the second exemplary embodiment.

When the driver locks the adjustment lever 613, the operation cam 730 and the fixed cam 710 are spaced apart from each other, thereby pulling the adjustable bolt 720 in one direction (i.e., in the direction where the head portion 721 compresses the second tilt locking gear 650). As a result, the gap between the plate brackets 611 is narrowed to compress the telescopic guide portions 607 and at the same time, to cause first gear teeth 803 of the first tilt locking gear 630 and the second gear teeth 653 of the second tilt locking gear 650 to be engaged with each other. Therefore, the tilt operation is completed, thereby accomplishing locking.

At this time, because the telescopic long holes 605 of the telescopic guide portions 607 are formed to be inclined by a predetermined angle θ in relation to the axial direction of the steering shaft 601, the telescopic operation is completed, thereby generating a locking effect.

That is, due to the telescopic long holes 605 formed to be inclined by the predetermined angle θ in relation to the axial direction of the steering shaft 601, the upper tube 610 should be moved in a tilt direction in order to perform the telescopic operation. However, because the upper tube 610 cannot be moved in the tilt direction due to the engagement of the first and second tilt locking gears 630 and 650, the tilt operation and the telescopic operation are simultaneously completed, thereby achieving locking.

On the contrary, when the driver releases the adjustment lever 613, the operation cam 730 and the fixed cam 710, which have been spaced apart from each other, are returned to the original positions thereof, causing the adjustable bolt 720 to move in the other direction. As a result, the gap between the plate brackets 611 which has been narrowed is expanded so that the upper tube 610 becomes movable in the axial direction and the second tilt locking gear 650, which has been engaged with the first tilt locking gear 630, is disengaged by the elastic supporting force of the elastic support 670. Consequently, the tilt operation and the telescopic operation become enabled.

As described above, according to the second exemplary embodiment of the present invention, since both the locking after the tilt operation and the locking after the telescopic operation can be achieved only with the tilt locking gears, it is possible to reduce the number of required elements, to reduce the material costs, and to configure the steering column in a compact size.

Even if all the constituent elements that form the exemplary embodiments of the present invention have been described above as being assembled in unison or operated by being assembled in unison, the present invention is not necessarily limited to the exemplary embodiments. In addition, the scope of the present invention shall be construed on the basis of the accompanying claims in such a manner that all of the technical ideas included within the scope equivalent to the claims belong to the present invention.

What is claimed is:

1. A steering column of a vehicle, comprising:
a hollow lower tube that encloses a steering shaft connected to a steering wheel; and
an upper tube formed in a hollow shape such that the lower tube is inserted into and coupled to the upper tube, and provided with telescopic guide portions that protrude from an outer circumferential surface of the upper tube to face each other and are formed with telescopic long holes, through which an adjustable bolt is coupled, the telescoping long holes being formed to be inclined by a predetermined angle in relation to a direction parallel to an direction of a central axis of the steering shaft, and a slot cut in the direction of the central axis of the steering shaft being formed at the outer circumferential surface between the telescopic guide portions.

2. The steering column as claimed in claim 1, wherein the telescopic long holes are formed to be inclined such that a distance between the steering wheel side ends of the telescopic long holes and the central axis of the steering shaft is longer than the distance between the other side ends and the steering shaft.

3. The steering column as claimed in claim 2, wherein the opposite ends of the telescopic long holes are formed to be rounded with a radius corresponding to the radius of the adjustable bolt.

4. The steering column as claimed in claim 1, further comprising:
a tilt locking gear assembly that includes a first tilt locking gear coupled to one side of plate brackets provided at both sides of the telescopic guide portions, a second tilt locking gear engaged with the first tilt locking gear, and an elastic support interposed between the first tilt locking gear and the second tilt locking gear to provide an elastic supporting force to the second tilt locking gear.

5. The steering column as claimed in claim 4, further comprising:
a cam assembly that includes a fixed cam which is coupled to the other side of the plate brackets and formed with a first cam protrusion, and an operation cam formed with a second cam protrusion which abuts on the first cam protrusion, the adjustment lever being coupled with the operation cam.

6. The steering column as claimed in claim 4, wherein the first tilt locking gear includes a first hole formed at a center thereof, the adjustable bolt being inserted through the first hole, and first gear teeth being formed at both sides of the first hole to be parallel to each other, and
wherein the second tilt locking gear is formed in a rectangular block shape and includes a second hole formed at a center thereof, the adjustable bolt being inserted through the second hole, and second gear teeth being formed at both sides of the second hole to be parallel to each other and engaged with the first gear teeth.

7. The steering column as claimed in claim 5, wherein the first tilt locking gear includes a first hole formed at a center thereof, the adjustable bolt being inserted through the first hole, and first gear teeth being formed at both sides of the first hole to be parallel to each other, and
wherein the second tilt locking gear is formed in a rectangular block shape and includes a second hole formed at a center thereof, the adjustable bolt being inserted through the second hole, and second gear teeth being formed at both sides of the second hole to be parallel to each other and engaged with the first gear teeth.

8. The steering column as claimed in claim 6, wherein the second tilt locking gear is formed with a stepped groove sunk in a polygonal shape around the second hole on the surface opposite to the surface formed with the second gear teeth, and
wherein the adjustable bolt inserted through the second hole of the second tilt locking gear is formed with a polygonal head portion at one end which is inserted into the stepped groove.

9. The steering column as claimed in claim 7, wherein the second tilt locking gear is formed with a stepped groove sunk in a polygonal shape around the second hole on the surface opposite to the surface formed with the second gear teeth, and
wherein the adjustable bolt inserted through the second hole of the second tilt locking gear is formed with a polygonal head portion at one end which is inserted into the stepped groove.

10. The steering column as claimed in claim 4, wherein the elastic support includes:
a hollow body portion, the second tilt locking gear abutting on the body portion to be supported; and
elastic support legs protruding toward the second tilt locking gear at both sides of the body portion and then bent toward the first tilt locking gear to be supported by the first tilt locking gear so as to provide an elastic supporting force to the second tilt locking gear.

11. The steering column as claimed in claim 5, wherein the elastic support includes:
a hollow body portion, the second tilt locking gear abutting on the body portion to be supported; and
elastic support legs protruding toward the second tilt locking gear at both sides of the body portion and then bent toward the first tilt locking gear to be supported by the first tilt locking gear so as to provide an elastic supporting force to the second tilt locking gear.

12. The steering column as claimed in claim 6, wherein the elastic support includes:
a hollow body portion, the second tilt locking gear abutting on the body portion to be supported; and
elastic support legs protruding toward the second tilt locking gear at both sides of the body portion and then bent toward the first tilt locking gear to be supported by the first tilt locking gear so as to provide an elastic supporting force to the second tilt locking gear.

13. The steering column as claimed in claim 7, wherein the elastic support includes:
a hollow body portion, the second tilt locking gear abutting on the body portion to be supported; and
elastic support legs protruding toward the second tilt locking gear at both sides of the body portion and then bent toward the first tilt locking gear to be supported by the first tilt locking gear so as to provide an elastic supporting force to the second tilt locking gear.

14. The steering column as claimed in claim 8, wherein the elastic support includes:
a hollow body portion, the second tilt locking gear abutting on the body portion to be supported; and
elastic support legs protruding toward the second tilt locking gear at both sides of the body portion and then bent toward the first tilt locking gear to be supported by the first tilt locking gear so as to provide an elastic supporting force to the second tilt locking gear.

15. The steering column as claimed in claim 9, wherein the elastic support includes:
a hollow body portion, the second tilt locking gear abutting on the body portion to be supported; and
elastic support legs protruding toward the second tilt locking gear at both sides of the body portion and then bent toward the first tilt locking gear to be supported by the first tilt locking gear so as to provide an elastic supporting force to the second tilt locking gear.
